(19) United States
(12) Patent Application Publication
(10) Pub. No.: US 2024/0429362 A1
(43) Pub. Date: Dec. 26, 2024

(54) METHOD FOR THE CONTINUOUS PRODUCTION OF A BATTERY ELECTRODE

(71) Applicant: Volskwagen Aktiengesellschaft, Wolfsburg (DE)

(72) Inventors: Sven SCHOPF, Braunschweig (DE); Wei WEI, Bruehl (DE); Vincent HOEFLER, Seggebruch (DE)

(73) Assignee: Volskwagen Aktiengesellschaft, Wolfsburg (DE)

(21) Appl. No.: 18/830,185

(22) Filed: Sep. 10, 2024

Related U.S. Application Data
(63) Continuation of application No. PCT/EP2023/055816, filed on Mar. 7, 2023.

(30) Foreign Application Priority Data
Mar. 10, 2022 (DE) 10 2022 105 656.2

(51) Int. Cl. H01M 4/04; H01M 4/1391; H01M 4/1393

(52) U.S. Cl. CPC H01M 4/0435; H01M 4/0404; H01M 4/1391; H01M 4/1393

(57) ABSTRACT

A method for the continuous production of a battery electrode from an electrode powder mixture. The electrode powder mixture having an active material, a binder material and a conducting additive. A powder mixture is first produced by adding the active material, the binder material and the conducting additive. The powder mixture formed is then pretreated using a mixer, during which pretreatment the powder mixture is mixed and homogenised and the binder is fibrillated. The powder mixture is then subjected to continuous impact-intensive comminution in order to form a pulverulent, free-flowing electrode powder mixture. The pulverulent, free-flowing electrode powder mixture that has been produced is then transferred by using a removal opening and via pouring and/or shaking with a desired width and thickness into a calender gap. Here, a film is produced from the electrode powder mixture in the calender gap, via shear forces inside the calender gap.

This nonprovisional application is a continuation of International Application No. PCT/EP2023/055816, which was filed on Mar. 7, 2023, and which claims priority to German Patent Application No. 10 2022 105 656.2, which was filed in Germany on Mar. 10, 2022, and which are both herein incorporated by reference.

### BACKGROUND OF THE INVENTION

### Field of the Invention

The invention relates to a method for the continuous production of a battery electrode from an electrode powder mixture, wherein the electrode powder mixture has an active material, a binder material, and a conducting additive.

### Description of the Background Art

A battery is an electrochemical-based storage device for electrical energy. A secondary cell [or accumulator] is a rechargeable battery. Batteries represent an important element for the future of battery electric vehicles, among other things. They are characterized by a high energy density and specific energy, a high cell voltage, a very long shelf life owing to small self-discharge, as well as a wide temperature range for storage and operation. On account of their high energy density, they are consequently accorded an important role in achieving long operating ranges for electric vehicles.

A battery comprises two electrodes, between which is located the electrolyte with freely movable charge carriers, and a separator, which is a porous membrane that insulates the two electrodes from one another. Lithium-ion batteries, for example, function by the means that individual lithium ions migrate back and forth between the electrodes and are deposited in the active materials of the electrodes during discharging and charging. During discharging, lithium is removed from the negative electrode, which customarily includes copper as a current conductor, and at the same time electrons are emitted. The active materials of the positive electrode of a lithium-ion battery include mixed oxides, for example, wherein graphites or amorphous carbon compounds generally are used in the positive electrode. The lithium is deposited in these materials. During discharging, the lithium ions move from the negatively charged electrode through the electrolytes and the separator to the positively charged electrode. At the same time, the electrons, as carriers of electricity, flow from the negatively charged electrode through an external electrical connection (a cable connection, for instance) to the positively charged electrode, which typically includes aluminum as the current conductor. This process is reversed during charging. In this case, the lithium ions move from the positively charged electrode through the electrolytes and the separator to the negatively charged electrode. The cell shapes made of the individual cell materials include cylindrical, prismatic, and laminated cell shapes, among others. Depending on the application case, one battery cell or multiple cells are used. For the case of multiple cells, they are connected in series in a module. The required capacity in this case determines whether multiple battery cells are connected in parallel. Multiple connected modules form a battery system.

In battery manufacture, it is especially necessary to take into account a variety of criteria and to observe manufacturing tolerances. This applies to coating defects, for example. Thus, special importance and relevance are accorded to the production of the electrodes, in particular, and the formulas and processes used therein. In electrode production, active materials are customarily mixed with binder materials and conducting additives and applied to metallic conductor films. The conducting additives improve and ensure the electronic conduction between the active material particles, which generally are only mediocre or poor conductors. Even when graphite, which is actually a good conductor, is used as a storage material, it is not possible to dispense with the addition of conducting additives to the anodes. The binder materials are electrochemically inactive materials whose task is to stabilize a mixture of active materials and conducting additives and to produce a contact with the collector. From this perspective, a sufficiently uniform distribution of the binder material should be achieved in order to permanently ensure good adhesion of the electrode layer within itself and to the collector with the smallest possible amount of the binder material. The conductivity must be developed homogeneously in the three-dimensional structures of the electrode layer and, in particular, toward the collector. Customarily, the known methods in electrode production include the mixing of the starting materials and a dispersing to obtain a suspension (slurry) or a paste. Depending on the method, a suspension or highly viscous paste is present after the dispersion. This is followed by the forming into a film on the collector and the drying thereof. Furthermore, the film is cut and rolled on the collector.

US 2014/0210129 A1 describes a method for producing a carbon electrode material capacitors. The method comprises the mixing of materials in a twin-screw extruder, wherein the mixture materials comprise a substantially unfibrillated binder and a carbon material. Subsequently, an extruding of the mixed materials through the die of a twin screw extruder takes place.

U.S. Pat. No. 5,566,888 describes a method and a device for recycling a resin component. A coated or plated resin component is roughly ground in this case. The roughly ground resin component is heated and extruded to produce an extruded strand or an extruded film. The extruded form is rolled and drawn. The rolled film is pulverized and separated into a base resin component and a coating film component or deposit piece component.

U.S. Pat. No. 6,284,192 B1 describes a method for extruding a zinc or nickel electrode material. For this purpose, a mixing takes place of a homogeneous batch of raw materials composed of a source of zinc or nickel and also contains, as an additive, essentially unfibrillated polytetrafluoroethylene (PTFE). The batch is conveyed in an extruder, and extruded there through a forming element.

In electrode production, a considerable portion of the required energy is allotted to drying and solvent recovery during wet coating. In this connection, a key problem resides in the production of thin and homogeneous electrode layers while at the same time maintaining high process speeds. Due to the use of pastes or suspensions (slurries), the problem additionally occurs that these are applied from dies or similar fluid dynamic components to the film or rollers as, e.g., an extrudate. As a result, because of the limited options for the die orifice, which must not fall below certain sizes, these extrudates have such large layer thicknesses that numerous rolling steps are necessary to achieve a target thickness for the film. In consequence, larger facilities with more processing steps are required, and greater material stress exists. Furthermore, it is more difficult to maintain manufacturing tolerances.

### SUMMARY OF THE INVENTION

It is therefore an object of the invention to provide a method that at least partially overcomes the abovementioned disadvantages of the prior art and permits a continuous production of a battery electrode for solvent-free electrode production.

According to an example of the invention, a method is provided for the continuous production of a battery electrode from an electrode powder mixture, wherein the electrode powder mixture has an active material, a binder material, and a conducting additive. The production of a powder mixture takes place first here, through addition of the active material, the binder material, and the conducting additive. This is followed by a powder pretreatment of the powder mixture formed of the active material, the binder material, and the conducting additive via a continuous mixer, wherein a powder mixing and homogenization and a binder fibrillation take place during the powder pretreatment. Next, a continuous, impact-intensive comminution of the powder mixture into a powdery and free-flowing electrode powder mixture takes place. In other words, formation of a wet or moist mixture similar to a paste or a suspension (slurry) is prevented. Next, the powdery and free-flowing electrode powder mixture that has been created is transported with a desired width and thickness to a calender nip via a discharge outlet, by trickling and/or pouring without the use of fluid mechanical components. On account of the essentially dry, free-flowing consistency of the electrode powder mixture, this can be accomplished according to the invention without the use of a die or a similar component. In other words, the electrode powder mixture is not forced through a die or the like in the form of a strand of extrudate using pressure, but instead can be discharged as a powdery and free-flowing electrode powder mixture by trickling, pouring, or dropping (downward). After that, a film is produced from the electrode powder mixture present in the calender nip through shear forces within the calender nip. The film is then transferred onto a current collector foil in a roller device, and the film on the current collector foil is compressed to form a battery electrode with a desired target thickness.

In particular, no solvent is added to the electrode powder mixture (comprising the active material, the binder material, and the conducting additive). In other words, the method is carried out essentially solvent free. This does not rule out the possibility that the abovementioned ingredients contain unavoidable residues or traces of solvents so that the free-flowing consistency is retained. In particular, the total solvent content in the electrode powder mixture is less than 0.2 percent by weight, preferably at most 0.1 percent by weight.

It is optionally possible that the film is rolled in further calender stages before the film is transferred to the current collector foil.

According to the conventional art, dies are customarily used on the extruder. A die is a technical device for influencing a fluid during the transition from flow through a pipe into free space; it forms the termination of the pipe here. The die customarily tapers along its entire length, and in connection with electrode production according to the prior art has special shapes at the exit in order to form a strand of extrudate.

It should be noted that the active material, the binder material, and the conducting additive can each be mixtures of multiple constituents.

Fibrillation can be understood to mean that the binder material, such as PTFE for example, which is initially present in particulate form, is drawn into “filaments” or “fibers.” This is accomplished via friction and shearing of the particulate binder material. Such a filament structure is required to ensure the mechanical quality of the product. Classic electrodes have PVDF binders that are dissolved and disperse in the form of small, fine globules and bind the materials. The preferred PTFE binder drawn into nanofilaments provides for the mechanical stability between the other particles through purely physical action of force.

In the following, it should apply for the present invention that secondary cells are also included as batteries.

During the powder pretreatment, the components are, among other things, mixed according to the formulas that include the amounts of the active material, binder material, and conducting additive. In this process, the mixture is homogenized sufficiently. A dispersion additionally takes place so that a uniform distribution of active particles, binder materials, and conducting additives takes place. In this process, an influx of energy into the powder mixture occurs. Each of the methods or the continuous mixers used for the purpose has its own characteristic curve with regard to the energy influx and the homogenization effect for the powder mixture in question. When the process is scaled up, the specific energy influx per volume fraction is the critical quantity.

In accordance with the method according to the invention, a continuous, impact-intensive comminution of the powder mixture takes place prior to the transport of the powdery and free-flowing electrode powder mixture. In order to ensure sufficient comminution of the powder mixture that is produced (flowability and further processing into homogeneous layers), increased impact-intensive stress is required. In this case, coupling the powder pretreatment with the continuous, impact-intensive comminution process is advantageous. The impact stress required for the comminution of the powder mixture produced by the powder pretreatment can therefore be increased by the means that a second, downstream process for ensuring the comminution effect is added. In this way, the size of the electrode powder particles can be further reduced and, in particular, any existing agglomerates that have formed during the binder fibrillation can be deagglomerated. The flowability is improved in this way, while at the same time a solvent is dispensed with.

The further comminution via an impact-intensive comminution process is preferably accomplished with an ultracentrifugal mill or opposed jet mill or impact mill. Especially preferably, a classifier mill is used for the further comminution. This mill provides a less intensive process that consequently is gentle on the materials, easy to monitor and control, and less expensive, since the classifier mill has lower process costs, in particular, than comparable facilities. Furthermore, reliable deagglomeration, which the classifier mill makes possible in an appropriate manner, is accorded great importance during this further comminution step.

In contrast to the solutions known until now, the method according to the invention permits continuous production of the battery electrode for solvent-free electrode production with a high degree of fibrillation without mechanically stressing the materials too severely. Because drying is not necessary, the additional energy input associated therewith can be avoided by this means. Furthermore, any rolling operations associated later with electrode production can be reduced so that the process costs are reduced, and gentleness of material treatment is enhanced, both for the facility and for the film that is produced. Scaling-up is simpler to accomplish on account of the powder mixing and homogenization and binder fibrillation in a single, continuous process step in place of multiple batch processes, which in some cases can be scaled to mass production only through numbering-up.

The adding of the components in this case can take place within the continuous mixer within which the powder pretreatment is carried out. In this case, the addition of the components within the continuous mixer can take place at different feed regions or jointly at one local feed region.

During the powder pretreatment, a comminution to improve the flowability optionally also takes place after the powder mixing and homogenization and a binder fibrillation.

The continuous mixer can be a twin-screw extruder or a continuous kneader/continuous internal mixer, and the powder mixing and homogenization, binder fibrillation, and the optional comminution during the powder pretreatment can be combined in the twin-screw extruder or in the continuous kneader. According to the invention, it is a continuous process. This process comprises the steps of powder mixing and powder homogenization, binder fibrillation, and the optional comminution. These three steps are carried out in a continuous mixer. Preferably the mixer is a twin-screw extruder or a continuous kneader. The use of a twin-screw extruder is an advantageous process variant to powder pretreatment because it permits the greatest possible flexibility for individual zones along the screw. In the zones, the activation is accomplished by shearing, if applicable slightly increased temperature, and thereby makes possible an optimized binder fibrillation.

A first and/or a second and/or a third zone may be present within the continuous powder pretreatment via a mixer. In this case, the first zone is designed such that it has a pronounced mixing and comminution effect for homogenization, the second zone is designed such that it has a high kneading and shearing effect for binder fibrillation, and the third zone is designed such that it has a less pronounced comminution effect for producing a free-flowing and non-dust-forming powder. The configuration of a continuous mixer thus has different zones. Within the mixer, the powder mixture undergoes a continuous process that comprises the steps of powder mixing and homogenization, binder fibrillation, and comminution. These steps consequently have different tasks as to how they are to affect the powder mixture. In this regard, the first zone should have a pronounced mixing effect as compared with the second and third zones in order to ensure a homogeneous powder mixture. This is important, especially in the present case, because a homogeneous mixture in dry form is more difficult to achieve in comparison with “wet” processes with solvent and the existence of a slurry, suspension, or paste. The second zone, in contrast, has the task of sufficiently fibrillating the binder material. In methods according to the prior art, the binder material is conventionally dissolved in a solvent. This can take place prior to adding to the mixer or within the mixer. During the later drying, the binder material settles between the individual particles and develops its binding effect. In the present case, however, this is to be avoided by the method according to the invention, since solvent for dissolving is to be dispensed with for the abovementioned reasons. In view of this circumstance, the fibrillation must be achieved in a mechanically assisted manner without the use of solvent, for which reason a corresponding second zone preferably is provided within the mixer. After powder mixing and homogenization and binder fibrillation have been accomplished, the constituents of the powder must be comminuted further in order to provide a free-flowing powder. This can be fostered by the optional comminution during the powder pretreatment. Especially in the case of this comminution, a third zone is provided, wherein the third zone should have characteristic features that have a stronger comminution effect as compared with the second zone. The first, second, and third zones are arranged along a conveying direction according to the order in which they are enumerated. For this purpose, preferably the first zone can be implemented through the screws of an extruder, for example, wherein the screws in the first zone have toothed wheels that form a grinding mill. The second zone can include a kneading machine, for example, that includes trapezoidal elements. The third zone can again have toothed wheels, wherein fewer toothed wheels are used here than in the first zone.

Preferably, the addition of the conducting additive can take place only after a powder mixing of the active material and the binder material. In this way, it is possible to avoid that the conducting additive wets mainly the binder, and the binder then can no longer be well deagglomerated and fibrillated. Alternatively, preferably only the active material and the conducting additive are initially mixed together in order to ensure the best possible bonding. The binder material then is not added to the mixture composed of active material and conducting additive until later.

The total amount of the binder material can be in the range from 0.2 to 2 percent by weight with respect to the total weight of the electrode powder mixture, in particular in the range from 0.4 to 1.6 percent by weight, preferably 0.5 to 1.2 percent by weight, and especially preferably is 0.75 percent by weight. An electrode powder mixture is provided that does not need to be dried following the process of its production. All of the binder material is activated, and the powder mixture maintains a powdery and free-flowing state throughout. Furthermore, the binder material is an inactive material. Because of this, a binder material specific to the mode of operation of the battery would not be required. Instead, the binder material has an adverse effect thereon, since it occupies a certain proportion of the total weight and total volume by reason of its presence, which is undesirable. In addition, the binder material has an electrically insulating effect, and in this way impairs the conductivity and the accessibility of the active materials. On account of the low proportion of binder, therefore, a high proportion of inactive material in the form of the binder is prevented, which has a beneficial effect on the action of a battery produced later from this electrode powder mixture.

Provision can advantageously be made that the battery electrode can be a cathode (positive electrode), wherein the total amount of the active material with respect to the total weight of the powder mixture is at least 95 percent by weight and comprises a mixed oxide composed of lithium and at least one metal, which is chosen from Ni, Co, Mn, Al. In this way, an electrode powder mixture is provided that has a high proportion of the active material. As a result of the method according to the invention and the optimized binder fibrillation and simultaneous dispensing with solvent, such a cathode nevertheless has high mechanical stability and excellent chemical properties. As a result of the dispensing with solvent, a drying step is eliminated, and the facility footprint is improved.

Provision can advantageously be made that the battery electrode can be an anode (negative electrode), wherein the total amount of the active material with respect to the total weight of the powder mixture is at least 95 percent by weight and comprises a graphite and/or SiOₓ. In this way, an electrode powder mixture is provided that has a high proportion of the active material. As a result of the method according to the invention and the optimized binder fibrillation and simultaneous dispensing with solvent, such an anode nevertheless has high mechanical stability and excellent chemical properties. As a result of the dispensing with solvent, a drying step is eliminated, and the facility footprint is improved.

Preferably, the percentile value D90 of the particle-size distribution of the electrode mixture can be less than 500 μm. In the case of such a particle-size distribution, the flowability of the powdery and free-flowing electrode powder mixture is improved so that further processing is simplified and can be accomplished more precisely. A percentile value of D90 less than 500 μm means in other words that 90% of the electrode powder mixture is smaller than 500 μm at most.

A homogenization with one another of the active material and binder material and optionally the conducting additive can be carried out in a separate process before the powder pretreatment of the powder mixture. This preferably is accomplished by milling the corresponding mixture, in particular via an ultracentrifugal mill.

The battery electrode can be an electrode of a lithium-ion. In this case, it is especially important to use small binder proportions and to distribute the conducting additive well.

As binder for the case of producing a cathode, PTFE is preferably used, especially preferably with primary particle sizes greater than 1 μm. Especially preferred conducting additives for this case are conductive graphites and carbon blacks, CNTs, and similar materials. The proportion of the conducting additives preferably is less than 4 percent by weight.

As binder for the case of producing an anode, a blend of PTFE and PVDF is preferably used. Preferably, the proportion of PVDF is reduced and alternative binder material is used that is electrochemically stable to the high negative potential of the anode, in particular PEO (polyethylene oxide) is used in this case. Especially preferred conducting additives correspond to those in the electrode powder mixture production for cathodes. The proportion of the conducting additives preferably is less than 4 percent by weight.

The invention further relates to a method for producing a battery electrode, wherein a transport of the created powdery and free-flowing electrode powder mixture into a collecting device of a calender and/or into a calender nip, which is to say a nip between two rollers rotating in opposing directions, takes place by sprinkling and/or pouring via a discharge outlet. In other words, the free-flowing powder is delivered directly from the output of the continuous mixer to a calender. The processes can also be connected to one another by a vacuum transport, for example. “Direct provision” within the meaning of the invention means a provision in the form of a sprinkling and/or pouring from the output of the continuous mixer, without the powder emerging from the calender into a subsequent processing step through a die or similar. Consequently, an intermediate transport between continuous mixer and calender can also take place, wherein even in this case the provision to the interposed transport process takes place in the form of this direct provision, which continues up to the calender. It is also possible for multiple calenders to be connected if the turnover of the continuous mixer is dimensioned appropriately. After this step, a forming of the electrode powder mixture as a roller-borne film is carried out in the calender. This is achieved through different rotational speeds of the rollers. After that, a transfer of the roller-borne film onto a current collector foil in the middle calender nip and compression of the roller-borne film on the current collector foil in the middle calender nip or a further calender nip take place to form a battery electrode with a desired target thickness. In this way, with the use of the electrode powder mixture created during the method, an appropriate further processing to form a battery electrode takes place by applying it to a current collector foil with the desired criteria and requirements described above.

Optionally, the forming into a roller-borne film is accomplished by different rotational speeds of the rollers. Prior to the transfer onto the current collector foil, this roller-borne film is passed through further calendering stages, where it is rolled.

The calender can be a multi-stage calender, in particular a four-roller calender. According to the method known in the conventional art, a paste or suspension (slurry) is produced in the mixer. The paste or suspension is a mixture of denser solids that are suspended in a liquid. It emerges from the mixer, normally as a strand of extrudate, via a die. In subsequent steps, rollers form this strand of extrudate into a film, wherein the width of the film is brought about by the rolling. In accordance with the present invention, a free-flowing electrode powder mixture is produced according to the invention in the continuous mixer. In a subsequent step, the free-flowing electrode powder mixture is applied to rollers of a calender. In this process, it is already possible to determine a desired width of a later film via the pouring and/or sprinkling. The free-flowing electrode powder mixture can be poured onto the rollers in a corresponding width for this purpose. Consequently, it is possible to dispense with the use of a die. In this way it is possible, among other things, to prevent adverse back pressures from arising on account of the narrowing opening of a die. Attempts are frequently made to limit this by correspondingly large openings in the die, but correspondingly large strands of extrudate are created by this means, however. Even though the die shape itself can reproduce different geometries at its output, what they all have in common is that the cross-section of the exit area of the die decreases compared with its inlet in order to build up pressure. During the subsequent rolling out, the presence of a minimum opening of a die results in an increased number of rolling operations until the strand of extrudate reaches a target thickness due to the repeated rolling, which likewise entails additional material stress. The rolling operations also have an effect on the wear of the facilities, for example. Furthermore, the costs for these components, such as dies, can be avoided and maintenance for these components is also no longer required. Moreover, dies cause high shear forces, which in turn can change the material in an undesirable manner. Furthermore, greater freedom in determining the geometry of a film, in particular with regard to the layer thickness, exists because of the free-flowing electrode powder mixture.

Especially preferably, the calender can have four rollers.

The transport of the created powdery and free-flowing electrode powder mixture into a collecting device of a calender and/or into a calender nip, which is to say a nip between two rollers rotating in opposing directions, can takes place by sprinkling and/or pouring via a discharge outlet. This is followed by the forming of the electrode powder mixture as a freestanding film in the calender. For this purpose, the rollers of the calender rotate with the same roller speed. Furthermore, a rolling of the freestanding film takes place in further calendering stages to reduce the film thickness and increase the film density. This freestanding film is transferred afterwards to a current collector foil and compressed in a roller device to form a battery electrode with a desired target thickness.

Optionally, the forming into a freestanding film can be accomplished by equal rotational speeds of the rollers. Prior to the transfer to the current collector foil, this roller-borne film is passed through further calendering stages, where it is rolled.

The various examples and embodiments of the invention cited in this application can be combined with one another to good advantage unless otherwise stated in the individual case.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic structure of a battery;

FIG. 2 shows in a combined facility and process diagram, a method for producing a battery electrode according to an example of the invention, wherein the method includes a twin-screw extruder;

FIG. 3 shows a flowchart of a method for producing a battery electrode according to an example of the invention; and

FIG. 4 shows a flowchart of a method for producing a battery electrode according to an example of the invention.

### DETAILED DESCRIPTION

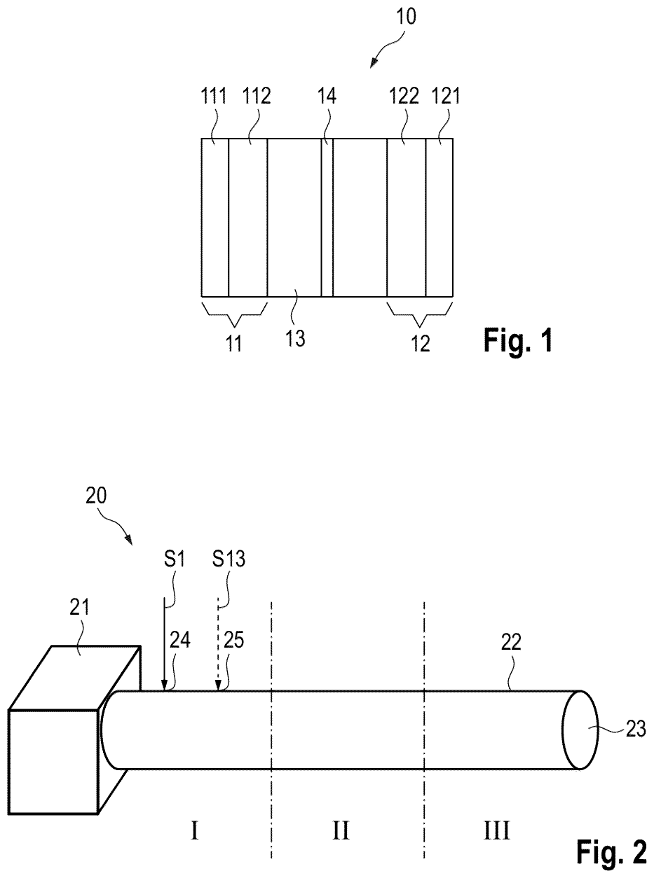

FIG. 1 shows a battery 10 that comprises two electrodes 11, 12, between which is located the electrolyte 13 with freely movable charge carriers, and a separator 14, which is a porous membrane that insulates the two electrodes 11, 12 from one another. The electrode 11 is the cathode of the battery, and has a current conductor of the cathode 111 and an active layer of the cathode 112 arranged on the current conductor 111. The electrode 12 is the anode of the battery, and has a current conductor of the anode 121 and an active layer of the anode 122 arranged on the current conductor 121. The current conductors of the cathode and anode 111, 121 are referred to hereinbelow as current collectors 111, 121, since they are produced from the current collector foil coated with the electrode powder mixture.

In a combined facility and process diagram, FIG. 2 shows a method for producing a battery electrode according to an embodiment of the invention that includes a twin-screw extruder 20. Here, the focus is on the twin-screw extruder 20 and its involvement in the method according to the invention and the connection to other (but not all) method steps in order to convey a better understanding of the action of the twin-screw extruder 20 in combination with other method steps.

The twin-screw extruder 20 includes a drive unit 21, which drives the screws arranged in the screw region 22 so that a mixing and conveying of a powder mixture takes place. The screws extend in the longitudinal direction along the screw region 22 and intermesh. Furthermore, they rotate in opposing directions because of the drive. Furthermore, the twin-screw extruder 20 has a discharge outlet 23, which makes possible the transport of the electrode powder mixture that is produced for downstream steps. This is accomplished via the discharge outlet 23 by trickling and/or pouring or dropping the electrode powder mixture out of the discharge outlet 23.

A conveying direction of the twin-screw extruder 20 takes place in the direction of the discharge outlet 23 starting from the drive 21. Furthermore, the screw region 22 includes a powder feed region 24 and an optional conducting additive feed region 25, or alternatively binder material feed region 25, arranged downstream of the powder feed region 24 in the conveying direction. Optional in this context does not mean that an addition of the conducting additive or alternatively binder material is dispensed with, but rather that an addition of the conducting additive or alternatively binder material can take place later than the addition of an active material and a binder material or, correspondingly, conducting additive. Alternatively, a later addition does not take place, but instead a joint addition with the active material and the binder material or conducting additive. This is illustrated by the method steps S1 and S13 connected with the respective feed regions 24, 25.

The delivery into the screw of the twin-screw extruder 20 of the materials to be processed is accomplished through, for example, a hopper that is located on top of the screw cylinder. In addition, according to a preferred embodiment of the invention, the screw region 22 includes a first zone I, a second zone II, and a third zone III. In this case, the first zone I is designed such that it has a pronounced mixing and comminution effect for homogenization, the second zone II is designed such that it has a high kneading and shearing effect for binder fibrillation, and the third zone III is designed such that it has a less pronounced comminution effect for producing a free-flowing and non-dust-forming powder. The screws therefore have a screw design that is appropriate for the objective in the respective regions.

Within the twin-screw extruder 20, the powder mixture undergoes a continuous process in the conveying direction that comprises the steps of powder mixing and homogenization, binder fibrillation, and comminution, wherein the individual steps are undergone along the previously employed sequence of steps in the conveying direction. Of course, the zones cannot be restricted entirely to one action, but among them the focus is intended, in particular, to be placed on one step each within the screw region 22. Return elements are arranged between the first and second zones I, II and between the second and third zones II, III.

In the first zone I, for example, the screws form a grinding mill that has toothed wheels that intermesh and in this way create a mixing and comminution effect. The second zone II, in contrast, includes a kneading machine that can be formed by trapezoidal elements. Consequently, a reduced comminution effect, but an increased fibrillation effect, is present here. The third zone Ill likewise has a grinding mill, wherein the number of intermeshing toothed wheels is reduced as compared with the grinding mill in the first zone I. Consequently, the comminution effect there is reduced.

During the method described later for producing a battery electrode, after their addition in the first zone I, the active material, the binder material, and the conducting additive are processed into a powder mixture via the screws, wherein the coarser constituents are comminuted via the grinding mill in the first zone I.

The powder mixture is transported in the conveying direction to the second zone II via the screws. In this process, coarser/granular constituents are held back via the return elements and are not allowed to pass through to the second zone II until they conform to the rest of the powder mixture emerging from the first zone I and have a suitable particle size. In the second zone II, the powder mixture is kneaded via the screws that comprise a kneading machine in this zone, and in the process the binder material is fibrillated. As soon as the binder material is fibrillated, a powder mixture is present in the second zone II that has the comminuted active material and conducting additive with which the binder material is mixed and cross-linked with the fibrillated binder material.

The powder mixture is transported in the conveying direction from the second zone II to the third zone Ill via the screws. In the optional third zone III, the fibrillated binder material is then further comminuted via the grinding mill located there. Subsequently, a completed electrode powder mixture is present that is conveyed out of the discharge outlet 23 via the screws, and consequently is discharged there.

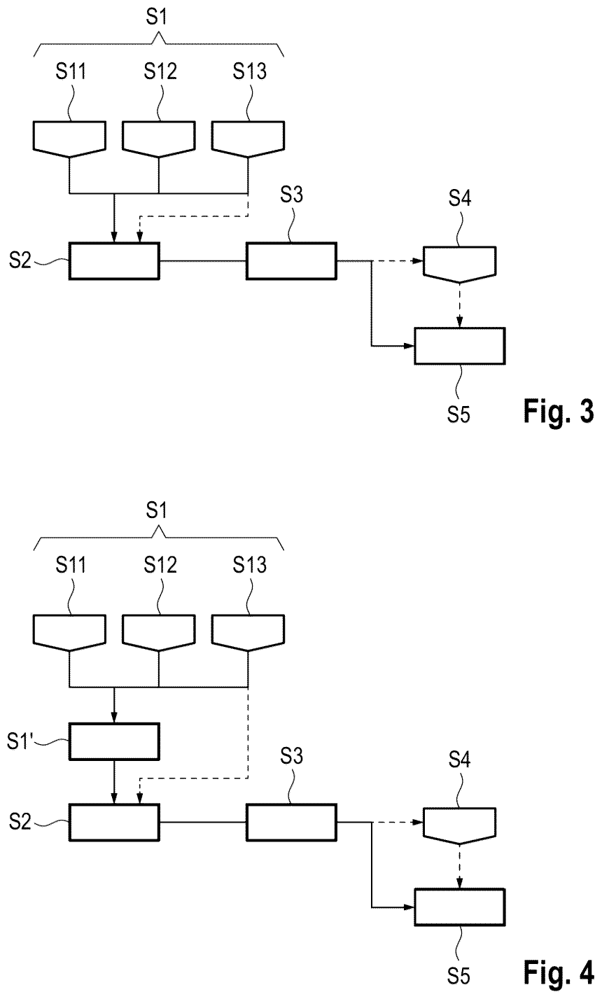

The method for producing a battery electrode according to a first embodiment of the invention is explained below on the basis of FIG. 3. Here, a twin-screw extruder 20 of the construction represented according to FIG. 2 is intended to be part of the method. FIG. 3 now shows a flowchart of the method for electrode production. In this case, the electrode production is, for example, produced in accordance with the method according to the invention for one of the two electrodes 11, 12, or both, wherein it should be noted that the starting materials are then different.

The method starts with step S1. This step comprises the adding of a powder mixture including an active material, a binder material, and a conducting additive. In this case, first the production of a powder mixture is accomplished by the addition of the active material in step S11, the binder material in step S12, and the conducting additive in step S13, through the powder feed region 24. The addition of the individual components in step S1 can take place jointly or, optionally, a component at a time through the individual steps S11, S12, and S13. In the present example, the addition of the conducting additive in step S13 can optionally not take place until after a powder mixing of the active material and the binder material through the steps S11 and S12. The adding in step S1 is carried out in the first zone I, wherein, in the case of a later addition of the conducting additive in step S13, this step takes place downstream in the conducting additive feed region 25, but likewise still in the first zone I.

This is followed by a powder pretreatment of the powder mixture composed of the active material, the binder material, and the conducting additive possibly added later in step S2, wherein a powder mixing and homogenization, a binder fibrillation, and an optional comminution take place during the powder pretreatment in step S2. The mode of operation of the different zones of the twin-screw extruder 20 has already been described here on the basis of FIG. 2.

In step S3, a further treatment is carried out of the electrode powder mixture discharged from the twin-screw extruder 20. In order to ensure sufficient comminution of the granulates produced (flowability and further processing into homogeneous layers), an impact-intensive stress is implemented here. The continuous process for powder pretreatment via the twin-screw extruder 20 is coupled with a continuous, impact-intensive comminution process. This step S3 can be carried out via an ultracentrifugal mill, an opposed jet mill, or in particular, a classifier mill.

Then, after the powder pretreatment and the continuous, impact-intensive comminution, the created powdery and free-flowing electrode powder mixture is transported into a collecting device of a calender and/or into a calender nip, which is to say a nip between two rollers rotating in opposing directions, by sprinkling and/or pouring via the discharge outlet 23. In other words, the electrode powder mixture is not forced through a die or the like in the form of a strand of extrudate using pressure, but instead can be discharged as a powdery and free-flowing electrode powder mixture by trickling, pouring, or dropping (downward). Storage of excess electrode powder mixture can optionally take place within a silo in the form of temporary storage in step S4 before further processing on a current collector foil via the calender.

In step 5, the electrode powder mixture is processed further to form a roller-borne or freestanding film. For this purpose, a roller-borne or freestanding film is produced from the electrode powder mixture present in the calender nip through shear forces within the calender nip. After that, the film is transferred onto a current collector foil 111, 121 in the middle calender nip, and the film on the current collector foil is compressed in a roller device to form a battery electrode 11, 12 with a desired target thickness.

FIG. 4 shows a flowchart of a method for producing a battery electrode 11, 12 according to a second embodiment of the invention. In this case, the method differs from the method described with reference to FIG. 3 in that the active material and the binder material or, if applicable, the conducting additive, are homogenized in a separate process before delivery to the continuous powder pretreatment in step S2. This can be accomplished via an ultracentrifugal mill in step S1′, for example. The remaining method steps do not differ from the method described with reference to FIG. 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the continuous production of a battery electrode from an electrode powder mixture that has an active material, a binder material, and a conducting additive, the method comprising:
producing a powder mixture by adding the active material, the binder material, and the conducting additive;
powder pretreating the powder mixture formed of the active material, the binder material, and the conducting additive via a continuous mixer, a powder mixing and homogenization and a binder fibrillation take place during the powder pretreatment;
continuous, impact-intensive comminuting the powder mixture into a powdery and free-flowing electrode powder mixture;
transporting the created powdery and free-flowing electrode powder mixture with a desired width and thickness to a calender nip via a discharge outlet by trickling and/or pouring;
producing a film from the electrode powder mixture present in the calender nip through shear forces within the calender nip; and
transferring the film onto a current collector foil in a roller device, and compressing the film on the current collector foil in a roller device to form a battery electrode with a desired target thickness.

2. The method according to claim 1, wherein the continuous, impact-intensive comminution is performed via an ultracentrifugal mill or opposed jet mill, or impact mill, or via a classifier mill.

3. The method according to claim 1, wherein the continuous mixer is a twin-screw extruder or a continuous kneader, and in that the powder mixing and homogenization and binder fibrillation are combined in the twin-screw extruder or in the continuous kneader.

4. The method according to claim 1, wherein a first and/or a second and/or a third zone are present within the continuous powder pretreatment, wherein the first zone is designed such that it has a pronounced mixing and comminution effect for homogenization, the second zone is designed such that it has a high kneading and shearing effect for binder fibrillation, and the third zone is designed such that it has a moderately pronounced comminution effect for producing a free-flowing and non-dust-forming powder.

5. The method according to claim 1, wherein the addition of the conducting additive takes place only after a powder mixing of the active material and the binder material, or wherein the addition of the binder material takes place only after a powder mixing of the active material and the conducting additive.

6. The method according to claim 1, wherein the total amount of the binder material is in the range from 0.2 to 2 percent by weight with respect to the total weight of the powder mixture, or in the range from 0.4 to 1.6 percent by weight, or 0.5 to 1.2 percent by weight, or is 0.75 percent by weight.

7. The method according to claim 1, wherein the battery electrode is a cathode (positive electrode), wherein the total amount of the active material with respect to the total weight of the electrode powder mixture is at least 95 percent by weight and comprises a mixed oxide composed of lithium and at least one metal, which is chosen from Ni, Co, Mn, Al.

8. The method according to claim 1, wherein the battery electrode is an anode (negative electrode), wherein the total amount of the active material with respect to the total weight of the electrode powder mixture is at least 95 percent by weight and comprises a graphite and/or SiOₓ.

9. The method according to claim 1, wherein no solvent is added to the electrode powder mixture.

10. The method according to claim 1, wherein the percentile value D90 of the particle-size distribution of the electrode powder mixture is less than 500 μm.

11. The method according to claim 1, wherein a homogenization with one another of the active material and binder material and optionally the conducting additive is carried out in a separate process before the powder pretreatment of the powder mixture.

12. The method according to claim 1, wherein the electrode powder mixture is used for lithium-ion battery electrodes.

13. The method according to claim 1, further comprising:
transporting the created powdery and free-flowing electrode powder mixture into a collecting device of a calender and/or into a calender nip, which is a nip between two rollers rotating in opposing directions, by sprinkling and/or pouring via a discharge outlet;
forming the electrode powder mixture as a roller-borne film in the calender; and
transferring the roller-borne film onto a current collector foil in the middle calender nip and compression of the roller-borne film on the current collector foil in a roller device to form a battery electrode with a desired target thickness.

14. The method according to claim 13, wherein the calender has at least four rollers.

15. The method according to claim 1, further comprising:
transporting the created powdery and free-flowing electrode powder mixture into a collecting device of a calender and/or into a calender nip, which is a nip between two rollers rotating in opposing directions, by sprinkling and/or pouring via a discharge outlet;
forming the electrode powder mixture as a freestanding film in the calender;
rolling the freestanding film in further calendering stages to reduce the film thickness and increase the film density; and
transferring the freestanding film onto a current collector foil and compression of the freestanding film on the current collector foil in the middle calender nip or a further calender nip to form a battery electrode with a desired target thickness.
